(19) United States
(12) Patent Application Publication
(10) Pub. No.: US 2008/0068941 A1
(43) Pub. Date: Mar. 20, 2008

(54) METHOD OF PROCESSING DEFECT DETECTION SIGNAL IN RECORDING AND/OR REPRODUCING APPARATUS THAT RECORDS AND/OR REPRODUCES OPTICAL INFORMATION STORAGE MEDIUM

(75) Inventors: Jong-hyun Shin, Suwon-si (KR); Tatsuhiro Otsuka, Suwon-si (KR); Kwan-joon Kim, Hwaseong-si (KR); Young-jae Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/693,168

(22) Filed: Mar. 29, 2007

(30) Foreign Application Priority Data
Sep. 14, 2006 (KR) 2006-89247

(51) Int. Cl. G11B 7/00

(52) U.S. Cl. 369/44.32

(57) ABSTRACT

A method of processing a defect detection signal in a recording and/or reproducing apparatus that records and/or reproduces an optical information storage medium the method including generating a defect detection signal comprising a servo hold pulse from a radio frequency (RF) signal output from an optical pickup unit; and generating an OR signal by performing an OR operation on the defect detection signal and a first pulse signal having a first pulse width. The method further includes generating an AND signal by performing an AND operation on the OR signal and a second pulse signal having a second pulse width.

### CROSS-REFERENCE TO RELATED APPLICATIONS

This application claims the benefit of Korean Patent Application No. 2006-89247 filed on Sep. 14, 2006, in the Korean Intellectual Property Office, the disclosure of which is incorporated herein by reference in its entirety.

### BACKGROUND OF THE INVENTION

1. Field of the Invention

An aspect of the invention relates to a defect detection signal of a recording and/or reproducing apparatus that records and/or reproduces an optical information storage medium, and more particularly to a method of processing a defect detection signal of an optical disk. The term “recording and/or reproducing apparatus” refers to an apparatus that record, or an apparatus that can reproduce, or an apparatus that can both record and reproduce.

2. Description of the Related Art

An optical disk recording and/or reproducing apparatus is widely used record and/or reproduce multimedia data, such as audio/video data and other digital data, because of a recording capacity and a quick access time of an optical disk, such as a Compact Disc (CD) or a Digital Versatile Disc (DVD). In particular, since the DVD introduced in the middle of 1990s has a storage capability of 4.7 GB on one side thereof, films having a running time of 2 hours, which had been difficult to store on prior information storage media, can be recorded and/or reproduced with clear and vivid image quality of MPEG-2 using the DVD, and accordingly usage and value of the DVD are increasing.

In general, an optical disk recording and/or reproducing apparatus reproduces a signal according to whether the intensity of light reflected to non-contact optical head is high or low. In particular, since the optical disk recording and/or reproducing apparatus uses the non-contact optical head, the optical disk recording and/or reproducing apparatus can prevent a quality decrease and have a reproduction capability that is relatively immune to dust or scratches on the surface of an optical disk as compared to recording media, such as a tape, that are recorded and/or reproducing using a contact head.

When an optical disk storage medium is not housed in a cartridge, various physical defects may easily occur during the use of the optical disk storage medium as compared to when the optical disk storage medium is housed in a cartridge. Such defects include, for example, a scratch, a fingerprint, a water drop mark, a black dot, a pin-hole like defect through which a laser beam is transmitted, and a defect which may occur during a disk manufacturing process and indicates that a portion of a data surface on which data is recorded is missing. In particular, during an optical disk coating process, a bubble defect due to absorption of an air bubble on a disk surface may occur.

These defects significantly affect an optical disk recording and/or reproducing apparatus since signal reproduction after a defect is impossible or hindered due to distortion or omission of a reproduced signal or malfunction of a servo signal required for the signal reproduction. Thus, the optical disk recording and/or reproducing apparatus generates a servo hold signal every time a specific defect is detected and generates a servo on signal after a defect zone ends.

FIGS. 1A and 1B show waveforms before, during, and after a defect detection period. FIG. 1A shows a servo error signal and a defect detection signal when a normal defect is detected. As shown in FIG. 1A, before a defect zone in which a defect occurs, the defect detection signal is in a servo on state, during the defect zone, the defect detection signal is in a servo hold state, and after the defect zone, the defect detection signal is in the servo on state again. That is, if a defect is detected, a servo hold signal having a high level is generated, and if no defect is detected, a servo on signal having a low level is generated.

If the defect zone is large enough to cause the defect detection period to exceed a certain time that depends on characteristics of the recording and/or reproducing apparatus and the optical disk, the servo control will be in a very unstable state by the time the defect detection signal returns to the servo on state, resulting in incorrect tracking.

FIG. 1B shows a servo error signal and a defect detection signal when a bubble defect is detected. As shown in FIG. 1B, when the bubble defect is detected, the servo error signal is irregularly generated unlike the case of the normal defect as shown in FIG. 1A, and accordingly the defect detection signal is relatively slowly generated in contrast to the case of the normal defect, and has a discontinuous form. In addition, the bubble defect affects a portion of an optical disk corresponding to a range of several thousand tracks. Thus, for an optical disk which has the bubble defect, the defect detection signal is generated in the form of servo hold on/servo hold pulses during the bubble defect zone as shown in FIG. 1B, and accordingly the waveform of the defect detection signal is very unstable in contrast to that shown in FIG. 1A.

That is, since a servo on period between the two servo hold periods is very short, servo control during the servo on period is very unstable, resulting in a tracking failure and an Error Correction Code (ECC) error, and since an angle of a bubble defect varies according to a size of the bubble defect, tracking of a correct track is impossible, resulting in a tracking error.

As described above, if the defect detection signal shown in FIGS. 1A or 1B is generated, servo control is unstable at a time when a defect zone starts, and a servo on signal is more unstable at a time when a servo hold signal ends, resulting in an incorrect optical focus and incorrect tracking.

### SUMMARY OF THE INVENTION

According to an aspect of the invention there is provided a method of changing a defect detection signal to enable stable servo control when a defect is detected in an optical disk recording and/or reproducing apparatus.

According to an aspect of the invention, there is provided a method of processing a defect detection signal in a recording and/or reproducing apparatus that records and/or reproduces an optical information storage medium, the method including generating a defect detection signal including a servo hold pulse from a radio frequency (RF) signal output from an optical pickup unit; and generating an OR signal by performing an OR operation on the defect detection signal and a first pulse signal having a first pulse width.

According to an aspect of the invention, the method may further include generating an AND signal by performing an AND operation on the OR signal and a second pulse signal having a second pulse width.

According to an aspect of the invention, the second pulse width may be not greater than a maximum servo hold period during which the recording and/or reproducing apparatus is capable of performing track following.

According to an aspect of the invention, a rising edge time of the AND signal may be the same as a rising edge time of the defect detection signal.

According to an aspect of the invention, the first pulse width may be equal to or longer than 20 μs.

According to an aspect of the invention, there is provided a recording and/or reproducing apparatus that records and/or reproduces an optical information storage medium, the apparatus including an optical pickup unit that outputs an electrical radio frequency (RF) signal generated by optically picking up information recorded on the optical information storage medium; an RF amplifier that generates a defect detection signal including a servo hold pulse from the RF signal output from the optical pickup unit; a defect processing unit that generates on OR signal by performing an OR operation on the defect detection signal and a first pulse signal having a first pulse width, and outputs a compensated defect detection signal generated based on the OR signal; and a servo signal processing unit that outputs a servo drive signal generated based on the compensated defect detection signal output from the defect processing unit.

According to an aspect of the invention, the defect processing unit may further generate an AND signal by performing an AND operation on the OR signal and a second pulse signal having a second pulse width, and outputs the AND signal as the compensated defect detection signal.

According to an aspect of the invention, the defect processing unit may include a first pulse generator that outputs the first pulse signal having the first pulse width beginning at a falling edge time of the servo hold pulse of the defect detection signal; a second pulse generator that outputs the second pulse signal having the second pulse width beginning at a rising edge time of the servo hold pulse of the defect detection signal; a first logic operation unit including a first input terminal that receives the first pulse signal, a second input terminal that receives the defect detection signal, and an output terminal that outputs the OR signal; and a second logic operation unit including a first input terminal that receives the second pulse signal, and an output terminal that outputs the AND signal as the compensated defect detection signal.

According to an aspect of the invention, the first logic operation unit may be an OR gate, and the second logic operation unit may be an AND gate.

According to an aspect of the invention, there is provided a method of processing a defect detection signal in a recording and/or reproducing apparatus that records and/or reproduces an optical information storage medium, the method including generating a defect detection signal including a servo hold pulse from a radio frequency (RF) signal output from an optical pickup unit; generating a first modified servo hold pulse having a pulse width equal to a pulse width of the servo hold pulse in the defect detection signal increased by a first pulse width; if a pulse width of the first modified servo hold pulse is not greater than a second pulse width, outputting a compensated defect detection signal including the first modified servo hold pulse; and if the pulse width of the first modified servo hold pulse is greater than the second pulse width, generating a second modified servo hold pulse having the second pulse width, and outputting a compensated defect detection signal including the second modified servo hold pulse.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIGS. 1A and 1B show waveforms before, during, and after a defect detection period;

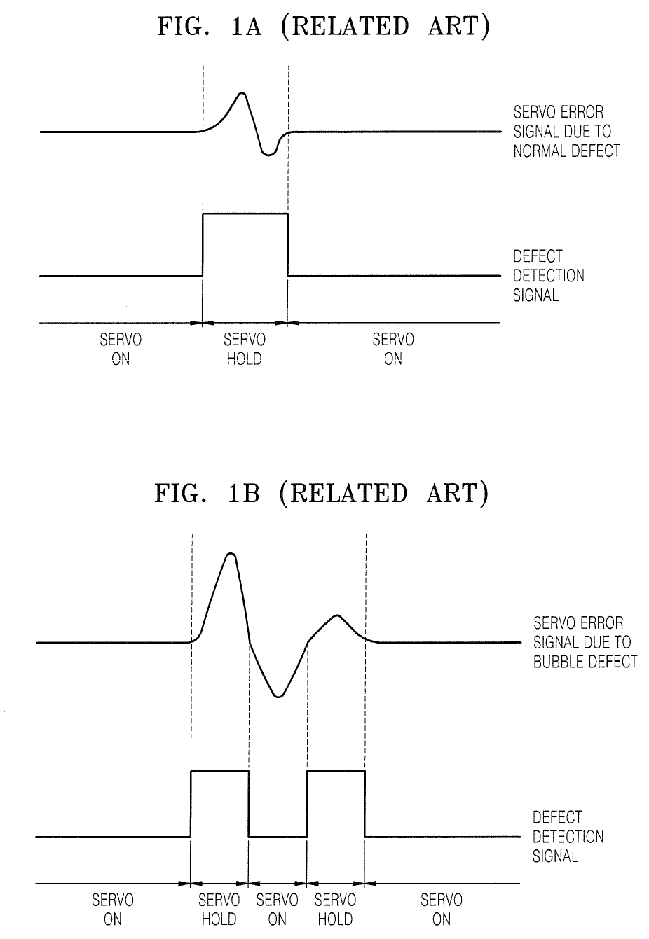

FIG. 2 is a block diagram of an optical disk recording and/or reproducing apparatus according to an aspect of the invention;

FIG. 3 is a block diagram of a defect processing unit shown in FIG. 2 according to an aspect of the invention;

FIG. 4 shows signals in the defect processing unit shown in FIG. 3 according to an aspect of the invention; and

FIG. 5 is a flowchart of a process of determining a second pulse width of a second pulse signal generated by a second pulse generator shown in FIG. 3 according to an aspect of the invention.

### DETAILED DESCRIPTION OF THE EMBODIMENTS

Reference will now be made in detail to embodiments of the invention, examples of which are shown in the accompanying drawings, wherein reference numerals refer to like elements throughout. The embodiments are described below in order to explain the invention by referring to the figures.

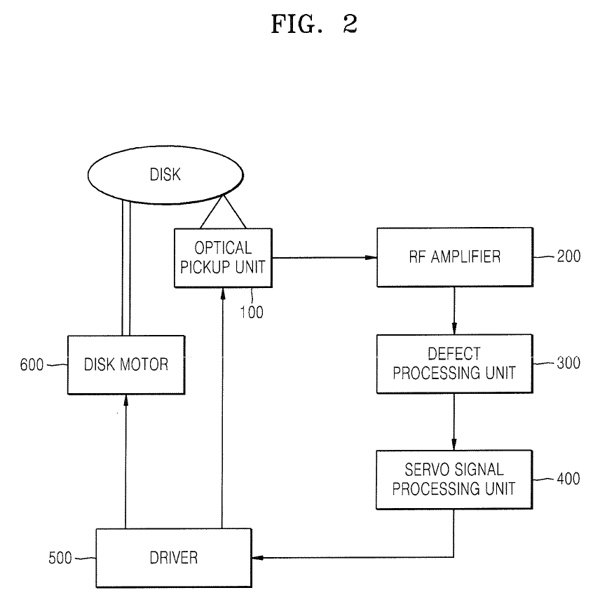

FIG. 2 is a block diagram of an optical disk recording and/or reproducing apparatus according to an aspect of the invention.

Referring to FIG. 2, the optical disk recording and/or reproducing apparatus includes an optical pickup unit 100, a radio frequency (RF) amplifier 200, a defect processing unit 300, a servo signal processing unit 400, a driver 500, and a disk motor 600.

The optical pickup unit 100 includes a tracking actuator (not shown) for tracking servo control and a focusing actuator (not shown) for focus servo control, and generates an electrical RF signal by optically picking up information recorded on a disk.

The RF amplifier 200 amplifies the RF signal output from the optical pickup unit 100. The RF amplifier 200 includes a focus error detection circuit (not shown) and a tracking error detection circuit (not shown) that generate focus and tracking servo error signals, i.e., a focus error (FE) signal and a tracking error (TE) signal, from the amplified RF signal.

The defect processing unit 300 outputs a compensated FE signal and a compensated TE signal by modifying a servo hold pulse of a defect detection signal to have a pulse width that corresponds to a size of a defect but is not larger than a predetermined pulse width, and changes a series of servo hold/servo on/servo hold pulses generated when a bubble defect occurs to a single servo hold pulse.

The servo signal processing unit 400 includes a focus servo control loop (not shown) and a tracking servo control loop (not shown) that output a focus drive (FOD) signal and a tracking drive (TRD) signal by compensating for a gain and focus of the compensated FE signal and the compensated TE signal output from the defect processing unit 300.

The driver 500 drives the disk motor 600, and the focusing actuator and the tracking actuator included in the optical pickup unit 100, using the FOD signal and the TRD signal output from the servo signal processing unit 400.

The disk motor 600 rotates the disk in a Constant Linear Velocity (CLV) mode or a Constant Angular Velocity (CAV) mode in response to a disk driving signal output from the driver 500.

A method of processing a defect detection signal of an optical disk using the defect processing unit 300 according to an aspect of the invention will now be described.

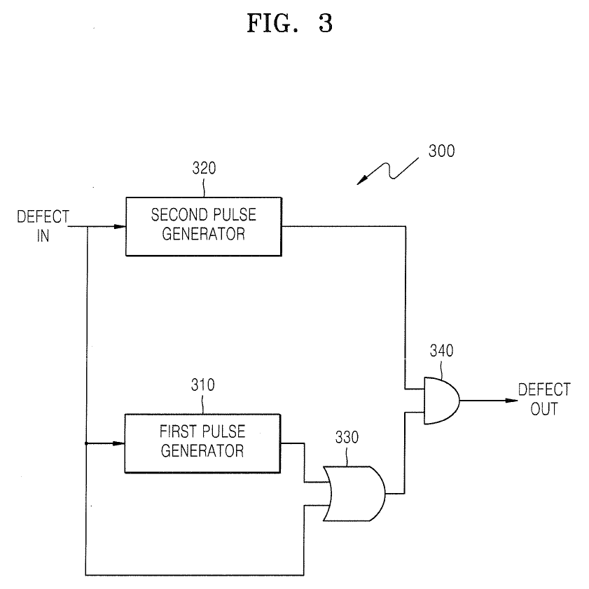

FIG. 3 is a block diagram of the defect processing unit 300 shown in FIG. 2 according to an aspect of the invention.

Referring to FIG. 3, the defect processing unit 300 includes a first pulse generator 310, a second pulse generator 320, an OR gate 330, and an AND gate 340.

When a defect detection signal defect_in is input from the RF amplifier 200, the first pulse generator 310 and the second pulse generator 320 respectively adjust a pulse width of a servo hold pulse included in the defect detection signal defect_in using a first register value and a second register value set therein.

The servo hold pulse width can be set according to a clock signal being used in a range between 1.8 μs and 460 μs using a first register (not shown) and a second register (not shown).

The first pulse generator 310 outputs a first pulse signal having a first pulse width set by the first register beginning at a falling edge time of the servo hold pulse.

The second pulse generator 320 outputs a second pulse signal having a second pulse width set by the second register beginning at a rising edge time of the servo hold pulse.

The OR gate 330 receives the first pulse signal output from the first pulse generator 310 and the defect detection signal defect_in through first and second input terminals thereof, and outputs an OR signal obtained by performing an OR operation on the two received signals.

The AND gate 340 receives the second pulse signal output from the second pulse generator 320 and the OR signal output from the OR gate 330 through first and second input terminals thereof, and outputs a compensated defect detection signal defect_out which is an AND signal obtained by performing an AND operation on the two received signals to the servo signal processing unit 400.

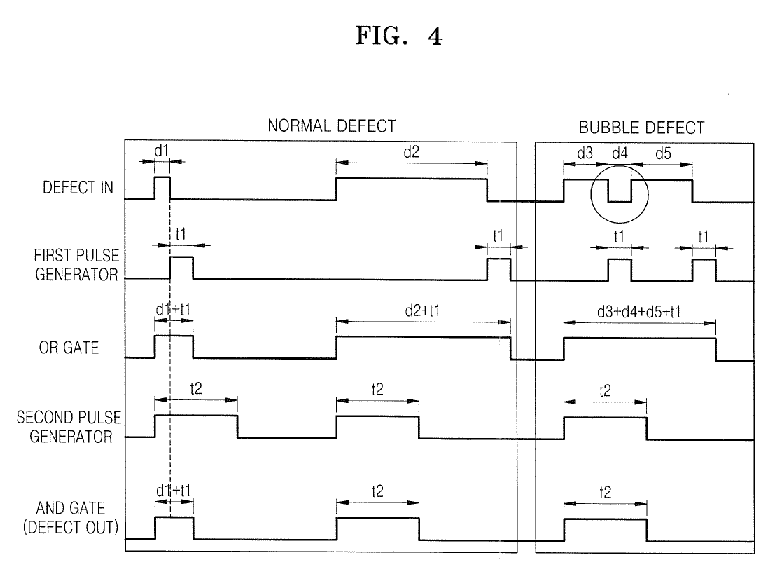

A method of processing a defect detection signal in the defect processing unit 300 according to an aspect of the invention will now be described with reference to FIG. 4.

FIG. 4 shows signals in the defect processing unit 300 shown in FIG. 3 according to an aspect of the invention.

Referring to FIG. 4, a method of processing a defect detection signal when a normal defect occurs and a method of processing a defect detection signal when a bubble defect occurs will be separately described. In FIG. 4, it is assumed that servo hold pulses having pulse widths d1 and d2 according to a size of the normal defect are input, and that servo hold/servo on/servo hold pulses having pulse widths d3, d4, and d5 according to a size of the bubble defect are sequentially input.

When a servo hold pulse having the pulse width d1 is input due to the occurrence of the normal defect, the first pulse generator 310 outputs a first pulse signal having a first pulse width t1 set by the first register beginning from a time when the input defect detection signal defect_in transitions from the servo hold state to the servo on state, i.e., beginning from a falling edge time of the servo hold pulse of the input defect detection signal defect_in.

When the first pulse signal output from the first pulse generator 310 and the defect detection signal defect_in are respectively input to the first and second input terminals of the OR gate 330, the OR gate 330 outputs an OR signal having a pulse width d1+t1 obtained by performing an OR operation on the two input signals.

That is, the OR gate 330 outputs a signal having a pulse width d1+t1 obtained by adding the pulse width d1 of the servo hold pulse to the first pulse width t1 of the first pulse signal output from the first pulse generator 310.

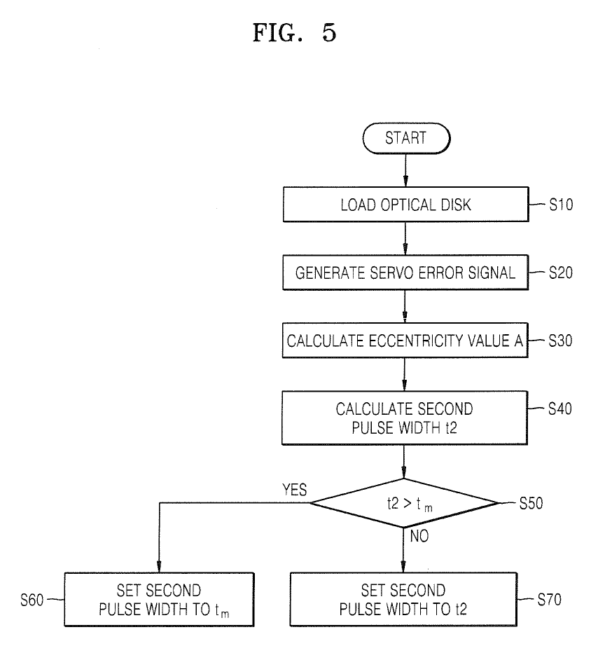

The second pulse generator 320 outputs a second pulse signal having a second pulse width t2 set by the second register beginning from a time when the input defect detection signal defect_in transitions from the servo on state to the servo hold state, i.e., beginning from a rising edge time of the servo hold pulse of the input defect detection signal defect_in. A method of determining the second pulse width t2 will be described later with reference to FIG. 5.

When the second pulse signal output from the second pulse generator 320 and the OR signal output from the OR gate 330 are respectively input to the first and second input terminals of the AND gate 340, the AND gate 340 outputs an AND signal having the pulse width d1+t1 obtained by performing an AND operation on the two input signals to the servo signal processing unit 400.

That is, the AND gate 340 selects a signal having a shorter pulse width from among the second pulse width t2 of the second pulse signal output from the second pulse generator 320 and the pulse width d1+t1 of the OR signal output from the OR gate 330, and outputs the selected signal having the shorter pulse width d1+t1 to the servo signal processing unit 400.

When a servo hold pulse having the pulse width d2 longer than the pulse width d1 is input, the first pulse generator 310 outputs a first pulse signal having the first pulse width t1 set by the first register beginning from a time when the input defect detection signal defect_in transitions from the servo hold state to the servo on state, i.e., beginning from a falling edge time of the servo hold pulse of the input defect detection signal defect_in.

When the first pulse signal output from the first pulse generator 310 and the defect detection signal defect_in are respectively input to the first and second input terminals of the OR gate 330, the OR gate 330 outputs an OR signal having a pulse width d2+t1 obtained by performing an OR operation on the two input signals.

The second pulse generator 320 outputs a second pulse signal having the second pulse width t2 set by the second register beginning from a time when the input defect detection signal defect_in transitions from the servo on state to the servo hold state, i.e., beginning from a rising edge time of the servo hold pulse of the input defect detection signal defect_in.

When the second pulse signal output from the second pulse generator 320 and the OR signal output from the OR gate 330 are respectively input to the first and second input terminals of the AND gate 340, the AND gate 340 outputs an AND signal having the second pulse width t2 obtained by performing an AND operation on the two input signals to the servo signal processing unit 400.

That is, the AND gate 340 selects a signal having a shorter pulse width from among the second pulse width t2 of the second pulse signal output from the second pulse generator 320 and the pulse width d2+t1 of the OR signal output from the OR gate 330, and outputs the selected signal having the shorter pulse width t2 to the servo signal processing unit 400.

As described above, by limiting a pulse width of a servo hold pulse to the second pulse width t2 when a defect size is too large, instability of the servo control in a subsequent servo on period can be prevented.

When a servo hold pulse having the pulse width d3, a servo on pulse having the pulse width d4, and a servo hold pulse having the pulse width d5 are sequentially input due to the occurrence of the bubble defect, the first pulse generator 310 outputs a first pulse signal having the first pulse width t1 set by the first register beginning from each time when the input defect detection signal defect_in transitions from the servo hold state to the servo on state, i.e., beginning from a falling edge time of each of the servo hold pulses of the input defect detection signal defect_in, wherein the first pulse width t1 must be equal to or longer than the pulse width d4 of the servo on pulse. The pulse width d4 of the servo on pulse is usually equal to or less than 20 μs, and accordingly the first pulse width t1 must be equal to or longer than 20 μs.

When the first pulse signal output from the first pulse generator 310 and the defect detection signal defect_in are respectively input to the first and second input terminals of the OR gate 330, the OR gate 330 outputs an OR signal having a pulse width d3+d4+d5+t1 obtained by performing an OR operation on the two input signals, thereby changing the series of servo hold/servo on/servo hold pulses of the input defect detection signal defect_in to a single servo hold pulse having the pulse width d3+d4+d5+t1.

The second pulse generator 320 outputs a second pulse signal having the second pulse width t2 set by the second register beginning from the first time when the input defect detection signal defect_in transitions from the servo on state to the servo hold state, i.e., beginning from a rising edge time of the first servo hold pulse of the input defect detection signal defect_in.

When the second pulse signal output from the second pulse generator 320 and the OR signal output from the OR gate 330 are respectively input to the first and second input terminals of the AND gate 340, the AND gate 340 outputs a signal having the second pulse width t2 obtained by performing an AND operation on the two input signals to the servo signal processing unit 400.

That is, the AND gate 340 selects a signal having a shorter pulse width from among the second pulse width t2 of the second pulse signal output from the second pulse generator 320 and the pulse width d3+d4+d5+t1 of the OR signal output from the OR gate 330, and outputs the selected signal having the shorter pulse width t2 to the servo signal processing unit 400.

Thus, by changing the series of servo hold/servo on/servo hold pulses that are generated due to the occurrence of a bubble defect to a single servo hold pulse having a pulse width not greater than the second pulse width t2, instability of the servo control due to the servo on pulse usually having a pulse width equal to or less than 20 μs can be prevented.

As described above, since a track displacement amount increases during a servo hold pulse generated in a defect zone, a track following performance cannot be ensured in a subsequent servo on period when a defect size is too large, and thus, according to an aspect of the invention, a pulse width of a servo hold period is limited to the second pulse width t2 to ensure a track following performance in the subsequent servo on period.

Although FIG. 4 shows a servo on level as being a low level, and a servo hold level as being a high level, the invention is not limited to this arrangement, and the defect detection processing unit shown in FIG. 3 according to an aspect of the invention can be modified to process a defect detection signal in which a servo on level is a high level, and a second hold level is a low level. The necessary modifications would be readily apparent to one of ordinary skill in the art, and thus will not be explained here.

A method of determining the second pulse width t2 of the second pulse signal generated by the second pulse generator 320 will now be described with reference to FIG. 5.

FIG. 5 is a flowchart of a process of determining the second pulse width t2 of the second pulse generated by the second pulse generator 320 shown in FIG. 3 according to an aspect of the invention.

Referring to FIG. 5, an optical disk is loaded in operation S10, and focus and tracking servo error signals are generated in operation S20 by turning on focus and tracking servos. A rotation frequency f, an eccentricity value A, and a phase of the TE signal (together known as eccentricity data) are calculated by extracting an eccentricity component of one period of the TE signal and converting the extracted eccentricity component to the eccentricity data. Since a method of calculating the eccentricity data from the eccentricity component is readily known to those skilled in the art, a detailed description of the method will not be provided.

After the eccentricity value A is calculated from the eccentricity component in operation S30, the second pulse generator 320 calculates the second pulse width t2 in operation S40 from the following Equation 1.

D_{c}=A·sin(2π·f·t2)<Dₘ (1)

Here, D_{c} is a measured detrack size indicating a total distance mismatched from a following track, A is the eccentricity value, f is the rotation frequency, t2 is the second pulse width, and Dm is a maximum detrack size. As can be seen from Equation 1, the second pulse width t2 is inversely proportional to the eccentricity value A.

As indicated in Equation 1, the measured detrack size Dc must be less than the maximum detrack size Dm. The maximum detrack size Dm is obtained by multiplying a track pitch tp of tracks of the optical disk by a critical number dm of tracks mismatched from a following track, which is a maximum mismatch at which track following can still be performed. The critical number Dm may be determined by experimentation.

After obtaining the second pulse width t2 using the above-described method, the second pulse width t2 is compared with a maximum servo hold pulse width tm in operation S50.

The maximum servo hold pulse width tm is a critical servo hold pulse width at which the optical disk recording and/or reproducing apparatus can still stably perform tracking when the servo hold state transitions to the servo on state, and is calculated from the following Equation 2.

$${t}_{m} = \frac{d}{v \cdot p} \qquad ( 2 )$$

Here, d denotes a maximum defect size after which tracking can be stably performed, v denotes a relative rotational speed of the optical disk (e.g., 1×, 2.4×, 4×, etc.), and p denotes a recording velocity (e.g., 3.49 m/s for DVD), wherein each parameter is determined according to the specifications of the optical disk.

If the calculated second pulse width t2 is greater than the maximum servo hold pulse width tm, the second pulse generator 320 sets the second pulse width to tm using the second register in operation S60.

If the calculated second pulse width t2 is equal to or less than the maximum servo hold pulse width tm, the second pulse generator 320 sets the second pulse width to t2 using the second register in operation S70.

That is, according to an aspect of the invention, when a pulse width of a servo hold pulse plus the first pulse width t1 is greater than the second pulse width t2 which is not greater than the maximum servo hold pulse width tm, the pulse width of the servo hold pulse is changed to the second pulse width t2 using the AND gate 340, thereby ensuring that the pulse width of the servo hold pulse is not greater than the maximum servo hold pulse width tm. Also, when the pulse width of the servo hold pulse plus the first pulse width t1 is equal to or less than the second pulse width t2 which is not greater than the maximum servo hold pulse width tm, the pulse width of the servo hold pulse is increased by the first pulse width t1 using the OR gate 330.

In addition, when a bubble defect occurs, a series of servo hold/servo on/servo hold pulses generated when a bubble defect occurs is changed to a single servo hold pulse having a pulse width equal to the sum of the pulses widths of the servo hold/servo on/servo hold pulses plus the first pulse width t1 using the OR gate 330. The pulse width of the single servo hold pulse is compared with the second pulse width t2 which is not greater than the maximum servo hold pulse width tm, and if the pulse width of the single servo hold pulse is greater than the second pulse width t2, the pulse width of the single servo hold pulse is changed to the second pulse width t2 using the AND gate 340, thereby ensuring that the pulse width of the servo hold pulse is not greater than the maximum servo hold pulse width tm. Also, if the pulse width of the single servo hold pulse is equal to or less than the second pulse width t2 which is not greater than the maximum servo hold pulse width tm, the pulse width of the single servo hold pulse produced using the OR gate 330 is not changed.

As described above, when a defect occurs, by constantly modifying a servo hold signal in response to a defect size, a servo on signal subsequent to the servo hold signal can be prevented from being unstable, resulting in an increase of the track following performance.

Aspects of the invention can also be embodied as a computer-readable medium encoded with computer-readable code for implementing a method of processing a defect detection signal according to aspects of the invention performed by a computer. The computer-readable medium may be any data storage device that can store data which can be thereafter read by a computer, such as read-only memory (ROM), random-access memory (RAM), CD-ROMs, magnetic tapes, floppy disks, and optical data storage devices. Also, aspects of the invention can be embodied in computer-readable code embodied as a computer data signal in a carrier wave, or as data transmitted over a network, such as the Internet. The computer-readable medium can also be distributed over network-coupled computer systems so that the computer-readable code is stored and executed in a distributed fashion.

As described above, according to an aspect of the invention, by constantly modifying a servo hold signal in response to a servo hold pulse width, instability of servo control that may occur when the servo hold signal falls after defect detection ends can be prevented, and a track following performance can be increased. In addition, even if a bubble defect occurs, the servo control can be stably performed during a subsequent servo on state.

Although several embodiments of the invention have been shown and described, it would be appreciated by those skilled in the art that changes may be made in these embodiments without departing from the principles and spirit of the invention, the scope of which defined in the claims and their equivalents.

What is claimed is:

1. A method of processing a defect detection signal in a recording and/or reproducing apparatus that records and/or reproduces an optical information storage medium, the method comprising:
generating a defect detection signal comprising a servo hold pulse from a radio frequency (RF) signal output from an optical pickup unit; and
generating an OR signal by performing an OR operation on the defect detection signal and a first pulse signal having a first pulse width.

2. The method of claim 1, further comprising generating an AND signal by performing an AND operation on the OR signal and a second pulse signal having a second pulse width.

3. The method of claim 2, wherein the second pulse width is not greater than a maximum servo hold period during which the recording and/or reproducing apparatus is capable of performing track following.

4. The method of claim 3, wherein the second pulse width is equal to the maximum servo hold period.

5. The method of claim 2, wherein the wherein the second pulse width is inversely proportional to an eccentricity value calculated from an eccentricity component of a tracking error signal generated from the RF signal output from the optical pickup unit.

6. The method of claim 2, wherein a rising edge time of the AND signal is the same as a rising edge time of the servo hold pulse of the defect detection signal.

7. The method of claim 2, further comprising outputting the AND signal as a compensated defect detection signal not comprising a servo hold pulse having a pulse width greater than the second pulse width.

8. The method of claim 1, wherein the first pulse width is equal to or longer than 20 μs.

9. The method of claim 1, wherein a rising edge time of the OR signal is the same as a falling edge time of the servo hold pulse of the defect detection signal.

10. The method of claim 1, wherein the defect detection signal further comprises a series of servo hold/servo on/servo hold pulses generated due to an occurrence of a bubble defect on the optical information storage medium;
wherein the first pulse width is equal to or longer than a pulse width of the servo on pulse; and
wherein the OR signal comprises a servo hold pulse obtained by converting the series of servo hold/servo on/servo hold pulses to a single servo hold pulse by performing the OR operation on the defect detection signal and the first pulse signal having the first pulse width.

11. A recording and/or reproducing apparatus that records and/or reproduces an optical information storage medium, the apparatus comprising:
an optical pickup unit that outputs an electrical radio frequency (RF) signal generated by optically picking up information recorded on the optical information storage medium;
an RF amplifier that generates a defect detection signal comprising a servo hold pulse from the RF signal output from the optical pickup unit;
a defect processing unit that generates an OR signal by performing an OR operation on the defect detection signal and a first pulse signal having a first pulse width, and outputs a compensated defect detection signal generated based on the OR signal; and
a servo signal processing unit that outputs a servo drive signal generated based on the compensated defect detection signal output from the defect processing unit.

12. The apparatus of claim 11, wherein the defect processing unit further generates an AND signal by performing an AND operation on the OR signal and a second pulse signal having a second pulse width, and outputs the AND signal as the compensated defect detection signal.

13. The apparatus of claim 12, wherein the defect processing unit comprises:
a first pulse generator that outputs the first pulse signal having the first pulse width beginning at a falling edge time of the servo hold pulse of the defect detection signal;
a second pulse generator that outputs the second pulse signal having the second pulse width beginning at a rising edge time of the servo hold pulse of the defect detection signal;
a first logic operation unit comprising a first input terminal that receives the first pulse signal, a second input terminal that receives the defect detection signal, and an output terminal that outputs the OR signal; and
a second logic operation unit comprising a first input terminal that receives the second pulse signal, a second input signal that receives the OR signal, and an output terminal that outputs the AND signal as the compensated defect detection signal.

14. The apparatus of claim 13, wherein the first logic operation unit is an OR gate.

15 The apparatus of claim 13, wherein the second logic operation unit is an AND gate.

16. The apparatus of claim 12, wherein the second pulse width is not greater than a maximum servo hold period during which the recording and/or reproducing apparatus is capable of performing track following.

17. The apparatus of claim 16, wherein the second pulse width is equal to the maximum servo hold period.

18. The apparatus of claim 12, wherein the second pulse width is inversely proportional to an eccentricity value calculated from an eccentricity component of a tracking error signal generated from the RF signal output from the optical pickup unit.

19. The apparatus of claim 12, wherein the compensated defect detection signal does not comprise a servo hold pulse having a pulse width greater than the second pulse width.

20. The apparatus of claim 11, wherein the first pulse width is equal to or longer than 20 μs.

21. The apparatus of claim 11, wherein the defect detection signal further comprises a series of servo hold/servo on/servo hold pulses generated due to an occurrence of a bubble defect on the optical information storage medium;
wherein the first pulse width is equal to or longer than a pulse width of the servo on pulse; and
wherein the OR signal comprises a servo hold pulse obtained by converting the series of servo hold/servo on/servo hold pulses to a single servo hold pulse by performing the OR operation on the defect detection signal and the first pulse signal having the first pulse width.

22. A method of processing a defect detection signal in a recording and/or reproducing apparatus that records and/or reproduces an optical information storage medium, the method comprising:
generating a defect detection signal comprising a servo hold pulse from a radio frequency (RF) signal output from an optical pickup unit;
generating a first modified servo hold pulse having a pulse width equal to a pulse width of the servo hold pulse in the defect detection signal increased by a first pulse width;
if a pulse width of the first modified servo hold pulse is not greater than a second pulse width, outputting a compensated defect detection signal comprising the first modified servo hold pulse; and
if the pulse width of the first modified servo hold pulse is greater than the second pulse width, generating a second modified servo hold pulse having the second pulse width, and outputting a compensated defect detection signal comprising the second modified servo hold pulse.

23. The method of claim 22, wherein the generating of the first modified servo hold pulse comprises:
generating a first pulse signal having the first pulse width;
generating an OR signal by performing an OR operation on the servo hold pulse in the defect detection signal and the first pulse signal; and
outputting the OR signal as the first modified servo hold pulse.

24. The method of claim 22, wherein the generating of the second modified servo hold pulse comprises:
generating a second pulse signal having the second pulse width;
generating an AND signal by performing an AND operation on the first modified servo hold pulse and the second pulse signal; and
outputting the AND signal as the second modified servo hold pulse.

25. The method of claim 24, wherein the second pulse width is not greater than a maximum servo hold period during which the recording and/or reproducing apparatus is capable of performing track following.

26. The method of claim 25, wherein the second pulse width is equal to the maximum servo hold period.

27. The method of claim 22, wherein the first pulse width is equal to or longer than 20 μs.

28. The method of claim 22, wherein the defect detection signal further comprises a series of servo hold/servo on/servo hold pulses generated due to an occurrence of a bubble defect on the optical information storage medium; and
wherein the method further comprises:
converting the series of servo hold/servo on/servo hold pulses in the defect detection signal into a single servo hold pulse;
if a pulse width of the single servo hold pulse is not greater than the second pulse width, outputting a compensated defect detection signal comprising the single servo hold pulse; and
if the pulse width of the single servo hold pulse is greater than the second pulse width, generating the second modified servo hold pulse having the second pulse width, and outputting a compensated defect detection signal comprising the second modified servo hold pulse.

29. The method of claim 28, wherein a pulse width of the servo on pulse is equal to or less than 20 μs; and
wherein the first pulse width is equal to or longer than 20 μs.

30. The method of claim 28, wherein the first pulse width is equal to or longer than a pulse width of the servo on pulse; and
wherein the converting of the series of servo hold/servo on/servo hold pulses in the defect detection signal into a single servo hold pulse comprises:
generating a first pulse signal having the first pulse width;
generating an OR signal by performing an OR operation on the series of servo hold/servo on/servo hold pulses in the defect detection signal and the first pulse signal; and
outputting the OR signal as the single servo hold pulse.
